(19) United States
(12) Patent Application Publication
(10) Pub. No.: US 2005/0192787 A1
(43) Pub. Date: Sep. 1, 2005

(54) Simulation apparatus and method of designing semiconductor integrated circuit

(75) Inventors: Yuji Kuwahara, Kanagawa (JP); Hiroki Shinde, Kanagawa (JP); Sachio Ogawa, Kanagawa (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/064,998

(22) Filed: Feb. 25, 2005

(30) Foreign Application Priority Data
Feb. 26, 2004 (JP) P. 2004-051336

(51) Int. Cl. G06F 17/50

(52) U.S. Cl. 703/18

(57) ABSTRACT

A simulation apparatus of a semiconductor integrated circuit, capable of measuring power consumption in a higher abstract degree than an RT level and in a high speed, is realized, so that a low power consumption designing operation can be carried out by employing a simulation result. While a cycle base model of a designing subject circuit is arranged by a state control module model, a calculation module model, and a memory model, in the calculation module model, an algorithm description is made; a detailed structure such as a pipeline of hardware is shortcircuited to a calculation to be processed in a unit clock; and a timing shift is absorbed in a wait state of the state control module model, so that a high-speed simulation can be realized. Since such information as an area and a wiring capacitance is added to an activating ratio measurement of a simulation model, power consumption can be measured. A priority arraigning/wiring operation of a function module is carried out based upon this measurement result, and then, a simulation is repeatedly performed so as to execute optimum arranging/wiring operations, so that low power consumption designing can be realized.

### BACKGROUND OF THE INVENTION

1. Field of the Invention

The present invention is related to a method of designing a system LSI. More specifically, the present invention is directed to a simulation model designing method in a simulation apparatus of an LSI, a power consumption estimating method using this model, and also, directed to a low power consumption designing method in a layout step and an arranging/wiring step based upon this estimated result.

2. Description of the Related Art

Very recently, in semiconductor integrated circuits such as system LSIs which have been manufactured in large scales, reductions of power consumption are strongly required. In particular, as to semiconductor integrated circuits used in portable terminals, utilization fields of these portable terminals are expanded to multimedia fields, for instance, Internet connections, TV telephones, reproductions of moving pictures under such a condition that lifetimes of batteries thereof are limited. Therefore, designing of low power consumption constitutes the most important aspect.

Conventionally, in general, power consumption of LSIs is predicted after actual arranging/wiring processes have been carried out by employing either an RT level or a net list. However, in order to estimate power consumption by using the RT level, the net list, and arranging/wiring information, a plenty of simulation time is necessarily required. Moreover, in order to simulate an entire integrated circuit which is manufactured in a large scale, a large-scaled computer with high performance, or the like are also required. Thus, there are some events that such a simulation cannot be carried out, depending upon scales of LSIs. Also, while short-term development of LSIs has been requested, there are some events that such processing steps used to estimate power consumption cannot be secured.

Under such a circumstance, as measure for solve the above-explained problems, the following technical idea has been proposed (for instance, see Japanese Laid-open patent Application No. 2001-338010). That is, the transaction analysis technique is utilized so as to predict power consumption. The technique disclosed in this patent publication 1 corresponds to such a technique which is sometimes utilized in a performance analysis called as a transaction. This performance analysis is applied to a prediction of power consumption, so that optimum solutions as to areas and power consumption are obtained in a floor plan step and an arranging/wiring step.

As steps of this designing method, an actual application program is executed, occurrence probability of various sorts of calculation process operations in circuits which should be designed is measured, and then, the measurement results are stored in a database. Alternatively, occurrence probability of the various sorts of calculation process contents is approximated by a normal distribution. Thus, the transaction analysis is carried out. Furthermore, since a database used to predict areas and energy data per unit area are provided, power consumption is predicted. Also, while a control data flow graph corresponding to an upper-grade level is used, an area is predicted, and after a function simulation has been carried out, operation is analyzed and power consumption is calculated.

The above-described technical idea corresponds to such a technique that the transaction analyzed results are statistically processed to be stored in the database in order to perform the estimation of the power consumption in the high speed, or another technique that the operation information is acquired by using the control data flow graph, and the acquired operation information is applied to the transaction analysis. In the former technique, since the transaction analyzed results are statistically processed, errors from the actual operations become large. Therefore, in order to construct the database, either the circuits to be designed or the equivalent operation models are required.

Also, as to the control data flow graph of the later technique, the improvement in the simulation speed may be expected, as compared with the method for employing the description of the RT level. However, the later technique owns the following problem. That is, if such an entire LSI is simulated which is arranged by both hardware and software containing installed software and application software, then lowered levels of simulation speeds cannot be neglected while scales of integrated circuits are increased. There is another problem that a simulation-returning-back process operation is increased in such a case that a specification cannot be satisfied while power consumption is predicted.

### SUMMARY OF THE INVENTION

An object of the present invention is to provide a power consumption estimating method in a high speed and in high precision, while a simulation model designing method is realized and this simulation model is employed. That is, in a simulation apparatus of a semiconductor integrated circuit, such a simulation model designing method is realized which is capable of executing a simulation in a high speed and in a higher abstract degree than the RT level by employing a general-purpose programming language such as the C language, in cooperation with installed software and the like. Another object of the present invention is to provide a low power consumption designing method capable of realizing low power consumption by employing this estimated result in a floor plan step and an arranging/wiring step, while suppressing a simulation-returning-back process operation in a minimum value.

In a simulation model designing method in a simulation apparatus of a semiconductor integrated circuit according to the present invention, hardware which should be designed is subdivided into a state control module model, a calculation module model, and a memory model so as to be designed. At this time, if a state control unit which is mounted on a hardware circuit to be designed is reproduced in a faithful manner while an internal register of the hardware circuit to be designed is employed as a variable, then a simulation speed is lowered. As a consequence, a state control of a circuit which should be designed is roughly subdivided into three states, namely, an idle state, an execution state, and an interrupt state. Furthermore, the execution state is subdivided into a memory read state, a calculation state, and a memory write state.

In the calculation module model, a content of a calculation which is processed in a data path of hardware is expressed by a formula. As this formula, it is desirable to employ such a formula which has been described by an algorithm. However, a loop structure which has been written in the algorithm and is frequently used is derived, and a content of a calculation is described which is processed by the hardware to be designed in a unit clock. As to the loop structure, an equivalent process operation may be realized by such a way that a counter is provided and a counter value is controlled every unit clock. Also, a pipeline structure of the circuit to be designed is not represented. Since these structures are employed, the variables are reduced, so that processing speeds may be increased.

However, when a modeling process is executed by using the above-described structure, both timing when the execution is commenced and timing when the execution is ended are shifted from those of the circuit to be designed. As a result, a timing shift for interrupt output may occur which constitutes an important factor when the circuit to be designed is operated in cooperation with installed software, and also, a shift may occur in a before/after relationship among a plurality of interruptions, so that processing operations of the software are different from the actual processing operations.

To avoid this problem, such a state of waiting for designated clocks is provided in the state control module model. This state may be transferred from all of other states, and also, may be transferred to all of other states. Since the above-explained structure is employed, the timing shift with respect to the hardware circuit can be absorbed while changes in the calculation module model are suppressed in a minimum change value. Also, since the above-explained concept of the unit clock corresponds to the function call of each of the calculation module models, the hardware modeling process can be carried out even by using a general-purpose programming language such as a C language.

In accordance with a power consumption estimating method of the present invention, a function simulation by the above-described simulation model is carried out, and an operating cycle number of each of the calculation module models at this time is estimated by monitoring a state of the state control module model. At this time, both a read access condition and a write access condition of the memory by the calculation module model are also measured power consumption by both the logic circuit and the memory can be predicted based upon the above-explained measurement result, areas of the respective calculation modules, power consumption per unit area, and power consumption of the memory per frequency, which are set outside the simulation apparatus.

Also, under this condition, no consideration is made as to power consumption required in wiring lines, especially, power consumption required in a wiring line between the function module and the memory. As a consequence, since distance information, a wiring width, and an arranging pitch are set from the external unit and are stored in the database, a load capacitance is calculated, and the power consumption caused by the wiring lines can be predicted.

Also, since the above-described power consumption calculating section is variable, power consumption can be analyzed in detail. When such a power consumption as a peak power analysis within a certain time is wanted to be analyzed in detail, since the power consumption calculation section is set to be short, the power consumption can be analyzed in detail. When the above-explained calculation section setting operation is carried out, since the calculation frequency is increased, the simulation speed is dropped.

However, when average power within a long section is wanted to be analyzed, since the calculation section is set to be a long calculation section, the calculation frequency is lowered, so that the high speed characteristic can be maintained. Also, since a process step for correcting the calculated power consumption value every calculation module is provided, an estimation can be realized in higher precision.

A low power consumption designing method, according to the present invention, is such a method for designing a semiconductor integrated circuit, comprising: a step A for determining an optimum solution of a relative position of each of function modules by a function simulation; a step BO for determining a power supply width and a power supply pitch based upon the power consumption value; a step B for determining an optimum arranging position of each of the function modules in view of timing; a step C for returning distance information, a wiring width, a wiring pitch, and a correction value form the arranging position to the function simulation; the step A, the step B, and the step C being repeatedly executed; and a step D for determining an optimum arranging position of each of the function modules. Based upon this method, a floor plan can be carried out by considering the power consumption from an earlier stage for designing the semiconductor integrated circuit, and the low power consumption can be realized.

In the step A for determining the optimum solutions of the relative positions of the respective function modules, first of all, a function simulation by the above-described simulation model is carried out, and at this time, both power consumption of the logic circuit and the memory, which contains the power consumption between the function modules, is predicted. As a result, as to interfaces of such function modules having high power consumption, since these interfaces are arranged adjacent to each other, a wiring distance is shortened and a wiring pitch is widened, and then, a simulation is again carried out. Since the above-described optimizing process operation of the power consumption is repeatedly carried out plural times, a relationship between the optimum relative positions and the optimum wiring pitches of the respective function modules can be determined at an earlier stage of designing the semiconductor integrated circuit.

In the step BO for determining both the power supply width and the power supply pitch based upon the power consumption value, a power supply is designed based upon the power consumption value predicted in the previous step. As a result, while referring to the detailed power consumption of the respective function modules, each of the function modules can be determined which uses an optimum power supply interval, an optimum power supply width, and an optimum ring power supply. Furthermore, when power consumption is estimated, the section is made narrow so as to measure peak power. Thereafter, a function module which cause this peak power is determined, and then, a wiring line of a power supply main route, or a use frequency of a capacitance cell is determined to the arranging position of this function module in a top priority, so that a more suitable power supply designing operation can be realized.

In the step B for determining the optimum arranging positions of the respective function modules in view of the timing, a floor plan is executed from the relative positions and the wiring positions of the respective function modules acquired in the step A. Thereafter, the wiring pitch, the wiring width, and the arranging position are optimized in view of the timing in order to satisfy the specification. As a result, the semiconductor integrated circuit can be designed by considering the power consumption from the initial stage of the floor plan.

In the step C for returning the distance information, the wiring width, the wiring pitch, the correction value from the arranging position to the function simulation, the detailed relative position and the detail relative wiring width of the function, the wiring pitch, and the correction value of the floor plan are extracted which have been optimized in view of the timing. As a result, a more detailed power consumption analysis can be carried out.

The method for extracting the wiring distance from the wiring position corresponds to such a method for acquiring gravity points of the respective function modules and for calculating distances between these gravity points. As a result of this method, in the case that function modules have expanses in view of layout, an averaged wiring distance can be calculated.

As the above-described method for extracting the wiring distance from the wiring position, there is another method for calculating the longest distance of the respective function modules. Since this alternative method is executed, as to such a function module as a memory which has been macro-processed, a wiring distance approximated to the actual wiring distance may be alternatively calculated. The above-described extractions of the wiring width and the wiring pitch may be carried out with respect to such a place that the values determined in the step A cannot actually satisfy the wiring characteristic and the timing requirement. As a result, while the more detailed power consumption is predicted in the step A, the optimum wiring widths and the optimum wiring pitches among the respective function modules can be determined.

The above-explained method for extracting the correction value corresponds to such a method that an insertion stage number of buffers is predicted based upon the wiring distance among the function modules, and then, the correction value is applied to the power consumption. Based upon this method, a more detailed power consumption analysis can be carried out by considering the layout information. As the method for extracting the correction value, another extracting method may be alternatively employed. That is, since the power consumption is predicted by applying the correction value with respect to the function module with strict timing from the threshold voltage, the threshold voltage of the function module may be determined.

In the step D for determining the optimum arranging positions of the respective function modules, while both the timing restriction and the power consumption specification are confirmed, the arranging positions of the respective function modules are finally determined. As a result, the power consumption of the semiconductor integrated circuit can be predicted in an earlier stage.

In accordance with the present invention, the simulation of the semiconductor integrated circuit can be executed in a very high speed rather than the RT level by employing the general-purpose programming language such as the C language. Such a high speed characteristic could be realized which is approximately 1000 times (average value) higher than that of the conventional simulation as an actual comparison ratio.

Also, in accordance with the power consumption estimating method of present invention, the power consumption can be estimated in high precision, namely, ±20% of the actual measurement value before the correction is made, and ±10% of the actual measurement value after the correction is made. Furthermore, in accordance with the low power consumption designing method of the present invention, while the simulation-returning-back process operation is suppressed to the minimum value within the floor plan step and the arranging/wiring step, the low power consumption designing can be realized.

### BRIEF DESCRIPTION OF THE DRAWINGS

FIG. 1 is a schematic diagram of a simulation apparatus equipped with a cycle base model based upon a simulation model design of a semiconductor integrated circuit, according to an embodiment mode 1 of the present invention.

FIG. 2 is a control data flow graph of actual hardware.

FIG. 3 is a schematic diagram of a simulation apparatus equipped with a cycle base model which absorbs a cycle error of the actual hardware and a simulation model.

FIG. 4 is a schematic diagram for indicating a simulation apparatus equipped with a power consumption measuring function of a semiconductor integrated circuit, according to an embodiment mode 2 of the present invention.

FIG. 5 is a flow chart for describing a low power consumption designing method of a semiconductor integrated circuit, according to an embodiment mode 3 of the present invention.

FIG. 6 is a diagram for explaining an example of a current optimization in the power consumption analysis of the floor plan step.

FIG. 7 is a graph for showing a characteristic as to power consumption-to-total area of power supply line, which is used to determine a power supply strengthening degree when a power supply is designed.

FIG. 8 is a graph for indicating a characteristic as to a wiring characteristic-to-power supply wiring width and power supply wiring pitch, which is used to determine both a power supply wiring width and a pitch when a power supply is designed.

FIG. 9 is a graph for representing power consumption characteristics of respective function modules, which is used to determine a power supply strengthening block.

FIG. 10 is a diagram for explaining a power supply designing method.

FIG. 11 is a diagram for explaining an example of optimizing a wiring characteristic.

FIG. 12(a), (b) are a diagram for explaining an example of optimizing timing when arranging/wiring operation is executed.

FIG. 13(a), (b) are a schematic diagram of a simulation apparatus equipped with a cycle base model based upon a simulation model design of a semiconductor integrated circuit, according to an embodiment mode 1 of the present invention.

FIG. 14 is a graph for showing a characteristic as to a drive type-to-averaged drive distance of a buffer cell.

FIG. 15 is a graph for representing a characteristic as to a drive type-to-use number of a buffer cell.

FIG. 16 is a diagram for explaining a model of a correction value between modules, which is fed back to a power consumption analysis.

FIG. 17 is a diagram for explaining a distance between hard macro modules.

FIG. 18 is a diagram for explaining a distance between modules having expanses which have not been macro-processed.

FIG. 19 is a flow chart for describing a low power consumption designing method of a semiconductor integrated circuit, according to an embodiment mode 4 of the present invention.

FIG. 20 is a diagram for indicating a structural example of a programmable logic gate array.

FIG. 21 is a diagram for indicating a mapping embodiment for mapping function blocks to the programmable logic gate array.

### DESCRIPTION OF THE PREFERRED EMBODIMENTS

### Embodiment Mode 1

Best embodiment modes of the present invention will now be explained in detail with reference to drawings. First, a description is made of a simulation model designing method having a high abstract degree and capable of realizing a high speed cycle base simulation, which corresponds to a first object of the present invention.

To this end, “function_b” is indicated as an algorithm model example of hardware which has been described by using a C language as follows:

void function_b(size_a,in0,in1)
{
int i, tmp;
for(i=0;i<size_a;i++){
tmp = mem0[i]+ mem1[i];
tmp *= in0;
tmp += in1;
mem2[i] = tmp;
}
}

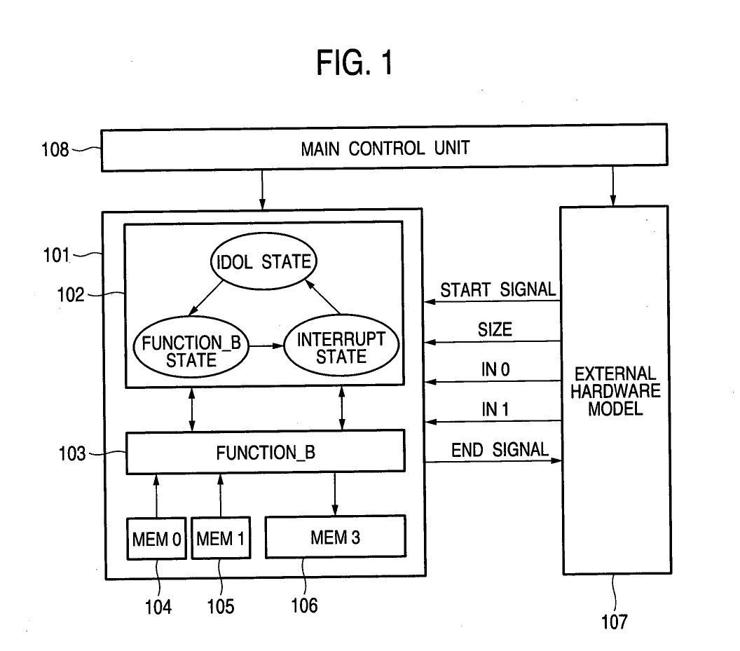

FIG. 1 is a schematic diagram for showing a simulation apparatus equipped with the high-speed cycle base model, according to the present invention, which corresponds to this algorithm model. A model 101 to be desingned is arranged by a state control module model 102, a calculation module model 103, and memory models 104, 105, 106. Also, there are a “start_signal” signal for notifying a start of a calculation, and an “end_signal” signal for notifying an end of a calculation as a communication with an external hardware model 107. There are “size a”, “in0”, and “in1” as calculation parameters. It should be noted that the external hardware model 107 may be alternatively realized by a processor model such as a CPU. Further, while the simulation apparatus is equipped with a main control unit 108 as a clock concept, one function call from the main control unit 108 corresponds to 1 clock.

Next, “data_path” of the calculation module model 103 is described as follows:

void data_path(size_a,in0,in1)
{
int tmp;
tmp = mem0[count] + mem1[count];
tmp *= in0;
tmp += in1;
mem2[count] = tmp;
count++;
}

In this calculation module model, although a calculation content is not so different from an algorithm model, a loop structure is deleted. To this end, while the simulation apparatus is equipped with a counter, since a loop is counter-controlled, a desirable data processing operation is realized.

This counter control is handled by a state control model “control_model”, and is described as follows:

void control1_model( )
{
switch(state){
case IDLE:
end_signal = 0;
count = 0;
if(start_signal) state = EXE
break;
case EXE:
data_path(size,in0,in1);
if(count==size) state = END;
break;
case END:
end_signal = 1;
state = IDLE;
break;
}
}

This state control module model contains an idle “IDLE” state, an execution “EXE” state, and an end “END.” Under initial state, this state control module model is positioned in the IDLE state. The IDLE state of this state control model is transferred to the execution “EXE” state in response to a start_signal signal supplied from an external unit. In the EXE state, the state control module model calls data_path of the calculation module model.

When a process size processed by the above-explained calculation module model is reached to a designated parameter size supplied from the external unit, the EXE state is transferred to the END state, and an end_signal signal is outputted to the external unit.

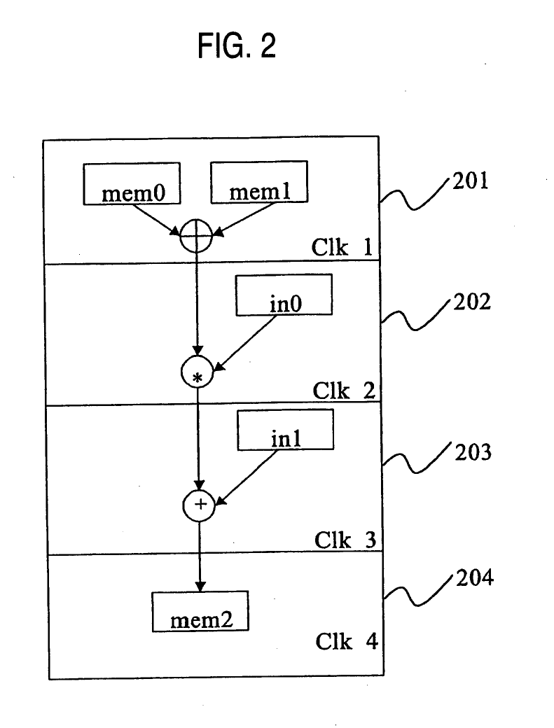

Next, a control data flow graph of actual hardware corresponding to the calculation module model is represented in FIG. 2. Alternatively, the actual hardware may be produced by synthesizing functions with each other so as to obtain the control data flow. While the actual hardware has been subdivided from a first stage 201 to a fourth stage 204, the actual hardware contains a pipeline structure.

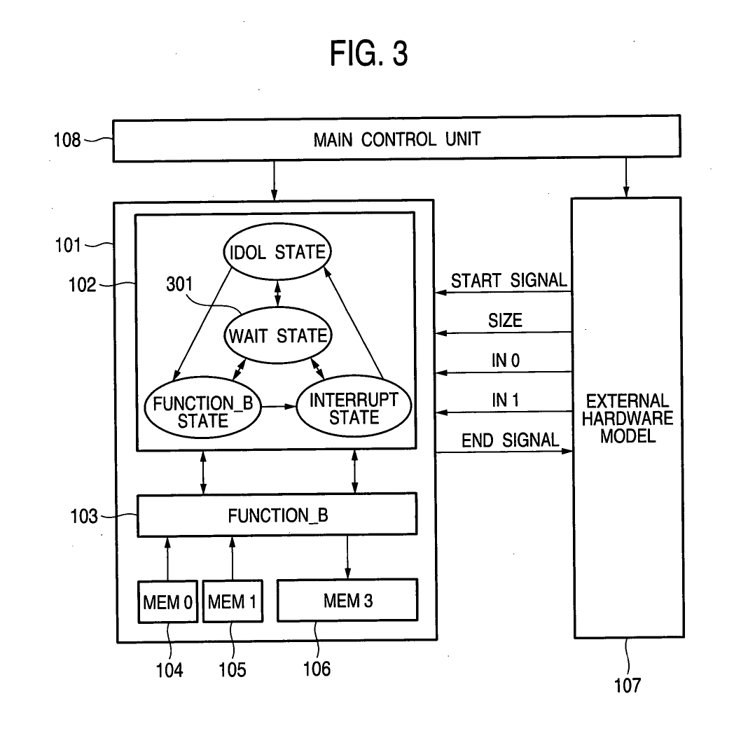

Since the actual hardware owns this pipeline structure, a shift of 3 clocks is produced between operation end timing of the actual hardware and operation end timing of the above-described cycle base model. FIG. 3 shows a schematic diagram as to a simulation apparatus equipped with a cycle base model which absorbs this shift. As a method for absorbing this shift, while no change is made to the above-explained calculation module model, a wait state 301 is provided in the above-described state control module model.

A description of this amended state control module model “control_model” is shown as follows:

void control1_model( )
{
switch(state){
case IDLE:
end_signal = 0;
count = 0;
if(start_signal) state = EXE
break;
case EXE:
data_path(size,in0,in1);
if(count==size){
state = WAIT;
wait_num = 3;
next_state = END;
}
break;
case END:
end_signal = 1;
state = IDLE;
break;
case WAIT:
wait_cnt++;
if(wait_cnt>=wait_num){
state = next_state;
wait_cnt = 0;
}
break;
}
}

In this case, when a processing size processed by the calculation module model is reached to a desirable processing size in the EXE state, the EXE state of the state control module model is transferred to a WAIT state. In the WAIT state, the state control module model waits a designated cycle number, and thereafter, the WAIT state thereof is transferred to an END state.

Since the cycle model is designed by such a manner, the high-speed cycle simulation can be realized by using the general-purpose programming language.

### Embodiment Mode 2

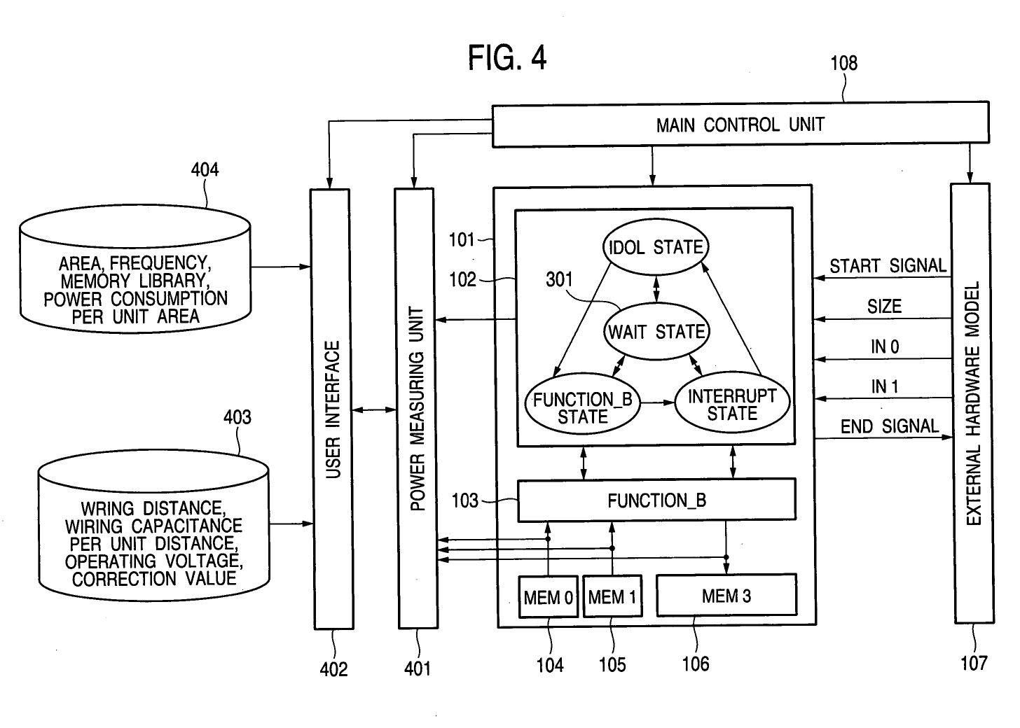

A description is made of a method for estimating power consumption in high precision from a simulation model of a high abstract degree, which corresponds to a second object of the present invention, with reference to the hardware model of the embodiment mode 1. FIG. 4 is a schematic diagram for indicating a simulation apparatus equipped with a power consumption measuring function. While software and the like which have been installed in this simulation apparatus are utilized, a simulation of an actual operation is executed so as to perform a power consumption measuring operation, so that an estimation of a power consumption value is obtained.

In this simulation apparatus, every time a certain constant section (T) set via a user interface 402 is elapsed, both an operation cycle number (Act) of the calculation module model 103 and access numbers (Actmem) of the memory models 104, 105, 106 are measured by the power measuring unit 401. The calculation module model 103 is used by the state condition module model 102, and the memory models 104, 105, 106 are used by the calculation module model 103.

While these measurement results, an operating frequency (f) of the calculation module model 103, an area (area) thereof, and power consumption (p) per unit area thereof, and power consumption (pmem) per unit frequency of a memory are used which have been set via the user interface 402 based upon a database 404, power consumption (pa) within the constant section (T) is measured. A calculation formula as to the power consumption Pa when the electric power is measured is given by the following formula (1):
Pa=(Act/T×area×p)+Actmem/T×(pmep×f) (Formula 1)

In this power consumption Pa, power consumption caused by a wiring line is not considered. In particular, such power consumption caused by wiring lines among the calculation module model 102, and the memory models 104, 105, 106 is not considered. As a result, power consumption (Pb) in the wiring lines is measured by utilizing respective wiring distances (d1, d2, d3) from the calculation module model 102 to the memory models 104, 105, 106; wiring capacitances (c1, c2, c3) of unit distances; an operating voltage (V); and also, bus widths (b1, b2, b3) of the respective memory models 104, 105, 106, which have been set via the user interface 402 based upon the database 403. A calculation formula as to this power consumption (Pb) is given by the following formula 2:
Pb=Actmem×(d1×c1×b1+d2×c2×b2+d3×c3×b3)×V\hat{ }2×f (Formula 2)

Alternatively, the wiring distances may be substituted by distances defined from the calculation module model 102 to other calculation module models. Furthermore, a correction value (x) which has been set by the external unit with respect to the power consumption Pb may be alternatively applied based upon the following formula 3:
Pb=Pb+x (Formula 3)

In this formula 3, while an initial value of the correction value (x) is set to zero, the precision of the power measuring operation may be improved by reflecting a content of a floor plan, and a content obtained in a physical design as to an arranging/wiring step. As previously explained, in accordance with this embodiment mode 2, even when the simulation model whose abstract degree is high is employed, the power consumption can be estimated in the high precision.

### Embodiment Mode 3

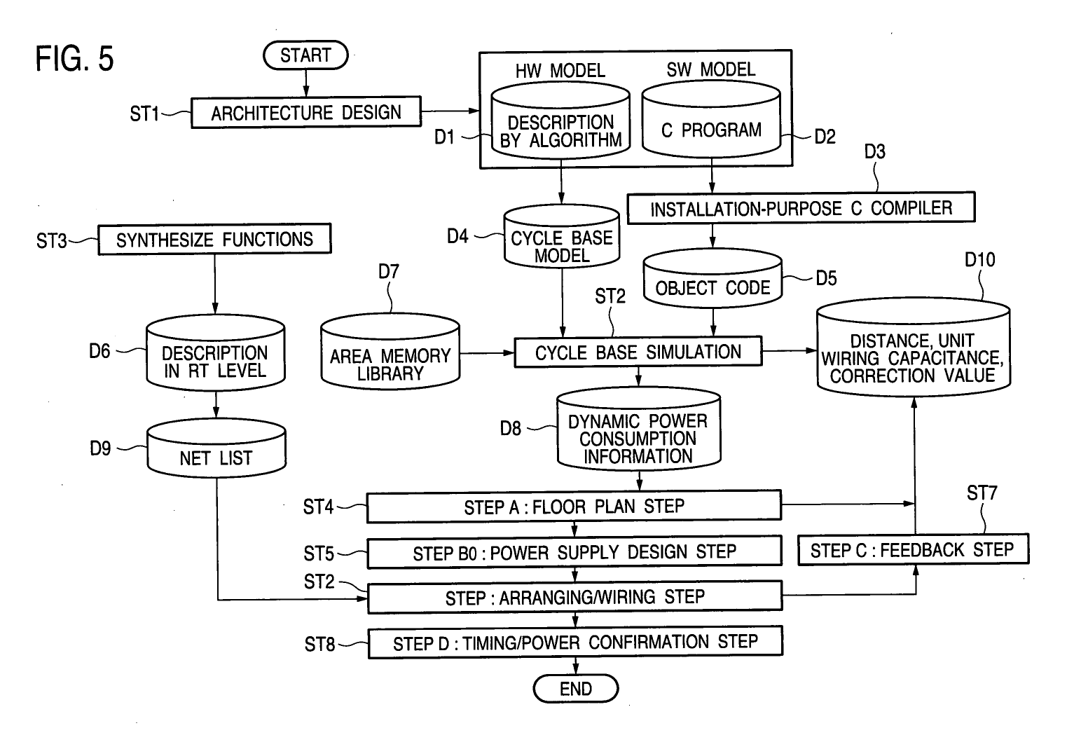

A description is made of a low power consumption designing method in both a floor plan step and an arranging/wiring step with employment of a power consumption estimation result obtained from a simulation model with a high abstract degree, which corresponds to a third object of the present invention. FIG. 5 is a flow chart for describing a low power consumption designing method of a semiconductor integrated circuit, according to an embodiment mode 3 of the present invention, while this low power consumption designing method is made based upon both the simulation model designing method of the embodiment mode 1 and the power consumption estimating method of the embodiment mode 2.

In FIG. 5, first of all, in an architecture design step ST1, both partitioning and detailed specifications as to both hardware and software are designed, and both a hardware model D1 of an algorithm description and a software model D2 of a C program are formed.

Next, based upon the simulation model designing method of the embodiment mode 1, a cycle base model D4 is designed, and also, an object code D5 is obtained by using an installation-purpose C compiler D3 as to the software model D2. Also, an RT level description D6 is produced from the cycle base model D4 by a function synthesizing step ST3. Alternatively, in this step ST3, the design may be made by a manual manner, not by synthesizing the functions. Furthermore, both an area and library information D7 are predicted from the RT level description D6.

In this step, while the cycle base model D4, the object code D5, the area, and the library information D7 are used, a cycle base simulation step ST2 is carried out in the power consumption measuring simulation apparatus by the power consumption estimating method of the embodiment mode 2 so as to acquire dynamic power consumption information D8.

Next, in a floor plan step ST4, since a power consumption analysis of each of the function modules is carried out by using the models formed in the previous steps, both relative positions and wiring pitches of the function modules are determined in such a manner that the power consumption may become optimum. In order to improve this optimization, a wiring capacitance per unit distance, which has been extracted from the relative position, the wiring width, and the wiring pitch of the function module, is fed back to the cycle base simulation ST2, and then, the power consumption measuring simulation is repeatedly executed.

Next, in a power supply designing step ST5, a power supply wiring area, a power supply wiring width, and a power supply pitch are determined based upon the power consumption analysis result, and a power supply designing operation is carried out. Next, in an arranging/wiring step ST6, an arranging/wiring operation is carried out based upon the relative positions and the wiring pitches of the respective function modules acquired in the floor plan step ST4, and a net list D9 produced from the RT level description D6. Thereafter, in order to satisfy the specification, optimizations of the wiring pitches, the wiring widths, and the wiring positions are carried out in view of timing.

Next, in a feedback step ST7, both a correction value D10 and a wiring capacitance per unit distance are extracted from the results obtained by optimizing the relative positions, the wiring lines, and the wiring pitches of the function modules in view of the timing in the arranging/wiring step S6. Then, the extracted correction value D10 and the extracted wiring capacitance per the unit distance are fed back to the cycle base simulation ST2.

While the process operations of the respective steps ST2, ST4, ST5, ST6 are repeatedly carried out in the above-described manner, both a timing restriction and a power consumption specification are confirmed in a timing and power confirming step ST8, and arranging positions of the respective function modules are determined.

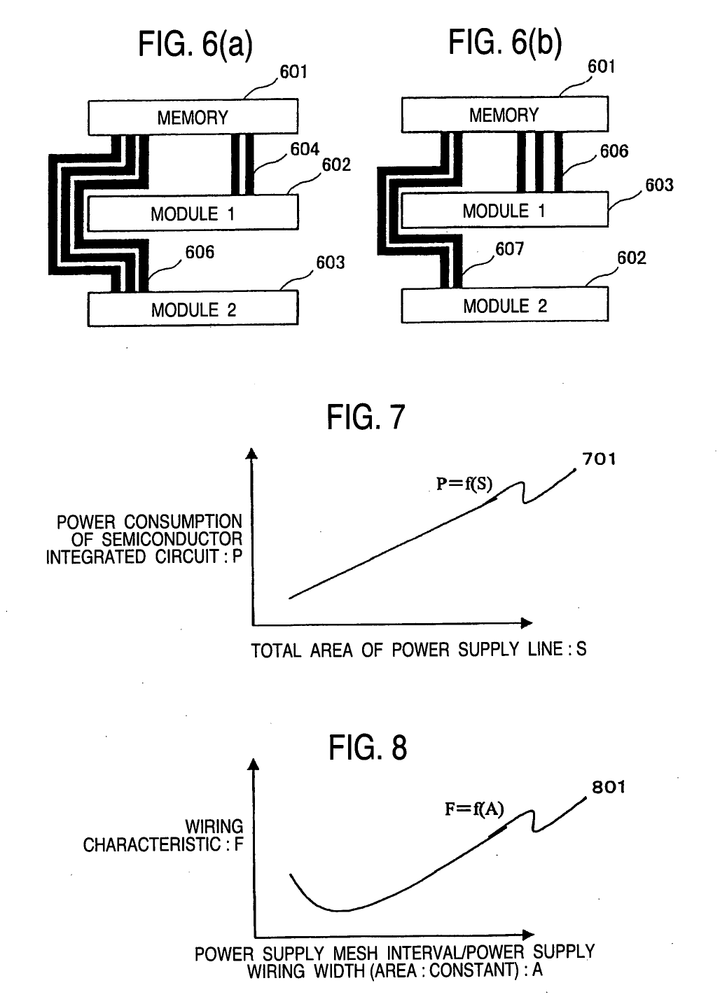

Next, detailed processing contents of the above-described respective steps will now be explained based upon concrete examples. FIG. 6 is a diagram for explaining an example in which the current optimizing operation in the floor plan step ST4 is carried out. In FIG. 6(a), reference numeral 601 shows a memory, reference numeral 602 indicates a module 1, reference numeral 603 represents a module 2, reference numeral 604 denotes a wiring line between the memory 601 and the module 1, and reference numeral 605 indicates a wiring line between the module 1 and the module 2.

In this case, such an arrangement is assumed that the module 1 is arranged relatively close to the memory 601 from the module 2, and the wiring pitches become a constant pitch. While this state is defined as an initial state, the power consumption measuring simulation is carried out. In the case that the power consumption of the module 2 is higher than the power consumption of the module 1, it is so predicted that the power consumption in the wiring line 605 is increased based upon this result. As a consequence, as indicated in FIG. 6(b), the module 2 is arranged adjacent to the memory 601, and a wiring pitch of a new wiring line 606 between the memory 601 and the module 2 is widened. The arranging position of the module 1 is relatively separated far from the memory 601, so that this module 1 is connected by employing a new wiring line 607.

The initial state explained in this example is one example. Generally speaking, this initial state is roughly predicted to be determined based upon an area and the library information D7, which correspond to such data indicative of a hardware scale of a function module. As previously explained, the simulation is repeatedly carried out while the power consumption measuring condition is changed with respect to the initial state so as to determine both the optimum relative wiring positions and the optimum wiring pitches.

Next, the contents of the power supply designing step ST5 will now be described in detail with reference to FIG. to FIG. 10. FIG. 7 is a graph used to determine a strengthening degree of a power supply, and reference 701 shows a characteristic related to both power consumption of a semiconductor integrated circuit and a total area of power supply lines. Based upon this characteristic, such a prediction is previously made. That is, how the area of the power supply is required with respect to the power consumption in order to satisfy the specification of the IR drop. Then, a total area of the power supply lines is determined based upon the analysis result of the power consumption in the floor plan step ST4.

FIG. 8 is a graph used to determine both a power supply width and a power supply pitch, and reference number 801 represents a wiring characteristic, and a characteristic of both a power supply mesh interval and a power supply wiring width. Based upon the characteristics, such a prediction is previously made. That is, how an optimum power supply mesh interval and an optimum power supply wiring width are required in order to satisfy the specification of the IR drop. Then, both a power supply mesh interval and a power supply wiring width are determined based upon the graph of FIG. 8.

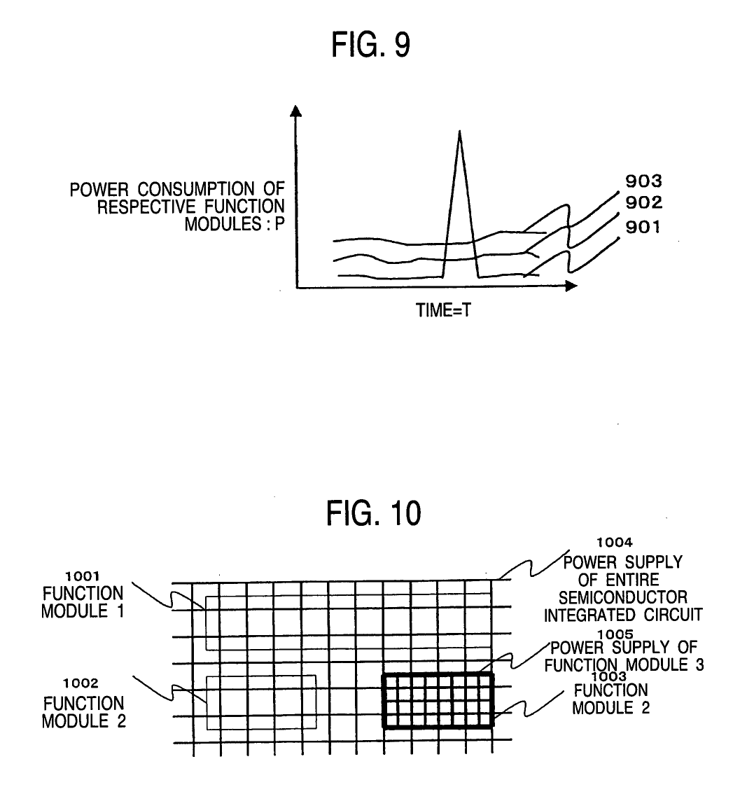

FIG. 9 is a graph as to the power consumption of the respective function modules which have been acquired in the power consumption analysis of the floor plan step ST4. In this graph, reference numeral 901 shows power consumption of the function block 1, reference numeral 902 indicates power consumption of the function block 2, and reference numeral 903 shows power consumption of the function block 3. In this case, since a large peak appears in a very small section in reference numeral 901, both a power supply strengthening block and/or a capacitance cell reinforcing block are determined.

FIG. 10 is a diagram for explaining designing of a power supply. In FIG. 10, reference numeral 1001 shows a function module 1, reference numeral 1002 indicates a function module 2, reference numeral 1003 represents a function module 3, reference numeral 1004 shows a power supply line of an entire semiconductor integrated circuit, and reference numeral 1005 denotes a power supply line of the function module 3.

The power supply line 1004 has been designed based upon both the power supply mesh interval and the power supply wiring width acquired from the power consumption analysis result of all of the function modules from FIG. 7 and FIG. 8. The power supply line 1005 establishes a power supply ring as to the function module 3 having the peak of the power consumption in FIG. 9, and the power supply mesh width is made narrow so as to strengthen the power supply. As explained above, designing of the power supply of the semiconductor integrated circuit is carried out in the power supply designing step ST5 based upon the power consumption analysis result of the floor plan step ST4.

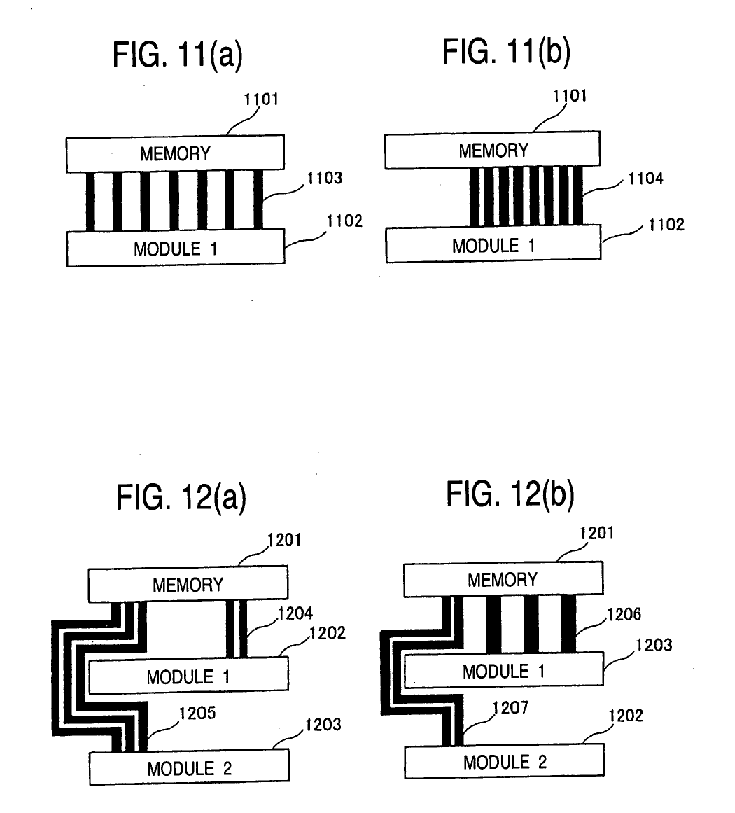

Referring now to FIG. 11 to FIG. 13, the content of the arranging/wiring step ST6 will be described. FIG. 11 is a diagram for explaining an example in which a wiring characteristic is optimized. In FIG. 11(a), reference numeral 1101 shows a memory, reference numeral 1102 indicates a module 1, and reference numeral 1103 represents a wiring line between the memory and the module 1. The condition of FIG. 11(a) corresponds to such a result that a floor plan is made by reflecting the result obtained in the power consumption analysis of the floor plan step ST4.

Although the power supply wiring pitch of the wiring line 1103 has been widened in order to reduce the power consumption, the wiring characteristic of the arranging/wiring process is deteriorated. As a result, as indicated in FIG. 11(b), while the relative position between the memory and the module 1 is not changed, the wiring pitch of the wiring line between the memory and the module 1 is narrowed and a new wiring line 1104 is employed, so that the wiring characteristic is improved. In this example, the wiring pitch is partially made narrow so as to relax the entire wiring characteristic. Alternatively, there is another method for changing a relative distance between the modules.

FIG. 12 is a diagram for explaining an example in which timing is optimized when arranging/wiring step is executed. In FIG. 12(a), reference numeral 1201 shows a memory, reference numeral 1202 indicates a module 1, reference numeral 1203 denotes a module 2, reference numeral 1204 represents a wiring line between the memory and the module 1, and reference numeral 1205 shows a wiring line between the memory and the module 2. The condition of FIG. 12(a) corresponds to such a result that a floor plan is made by reflecting the result obtained in the power consumption analysis of the floor plan step ST4.

A description is made of such a case that timing of the module 1 is severer than timing of the module 2. FIG. 12(b) shows a result of a rearranging/wiring operation. While the position of the memory 1201 is not changed, the position of the module 1 is replaced by the position of the module 2. The module 2 is arranged adjacent to the memory 1201. The wiring line 1205 is processed in such a manner that the wiring width thereof is widened and the wiring pitch there of widened so as to constitute a new wiring line 1206. As a result, both a wiring resistance and a wiring capacitance are lowered so as to make a merit in view of timing.

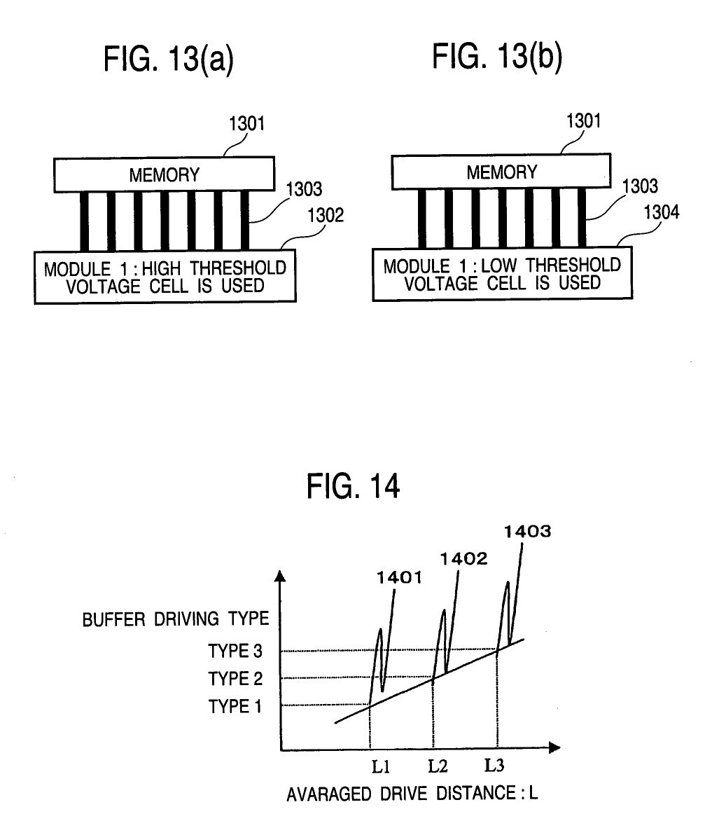

FIG. 13 is a diagram for explaining another example in which timing is optimized when arranging/wiring step is executed. In FIG. 13(a), reference numeral 1301 shows a memory, reference numeral 1302 indicates a module 1 and reference numeral 1303 represents a wiring line between the memory and the module 1. The condition of FIG. 13(a) corresponds to such a result that a floor plan is made by reflecting the result obtained in the power consumption analysis of the floor plan step ST4.

In this example, the following case is explained. That is, while the memory is arranged adjacent to the module 1, although both the wiring width and the wiring interval of the wiring line 1303 are widened, the timing at the wiring line 1303 is severe. FIG. 13(b) is a result obtained when the wiring line 1303 is rearranged and wired. While the arranging/wiring processes of the wiring lines as to the memory, the module 1, and the arranging/wiring process of the wiring line between the memory and the module 1 are not changed, the timing is advantageously set by changing a sort of cell used in the module 1 into a cell 1303 which is operated under lower threshold voltage.

Next, a description is made of the content of the feedback step ST7 with reference to FIG. 14 to FIG. 16. FIG. 14 is a graph for graphically showing a characteristic as to both drive types of buffer cells and averaged drive distances of these buffer cells which have been used. In FIG. 14, reference numeral 1401 indicates an averaged drive distance L1 of a type 1, reference numeral 1402 shows an averaged drive distance L2 of a type 2, and reference numeral 1403 represents an averaged drive distance L3 of a type 3. These distances correspond to a result which is extracted from the floor plan result.

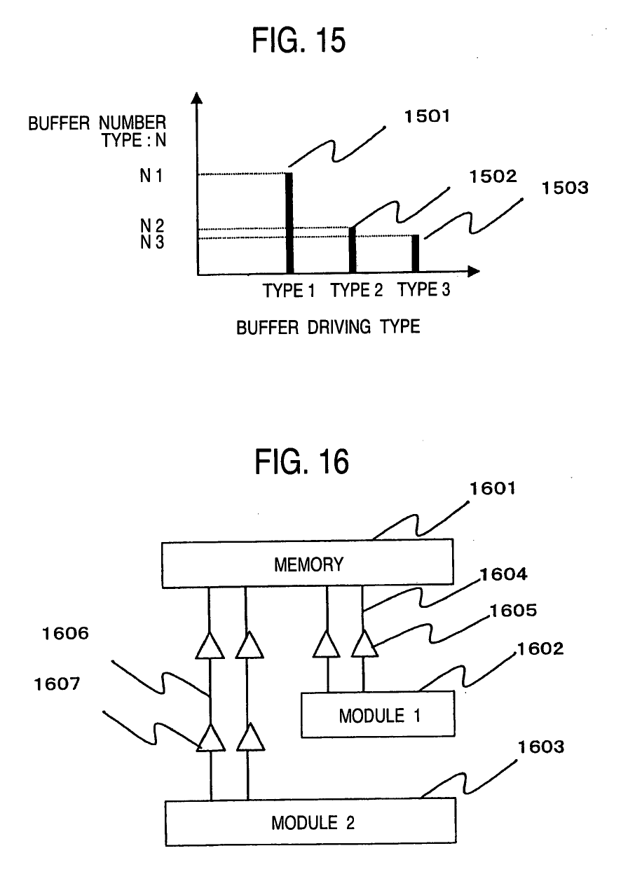

FIG. 15 shows a characteristic as to the drive types of the buffer cells and use numbers thereof. Reference numeral 1501 indicates a use number N1 of the type 1, reference numeral 1502 represents a use number N2 of the type 2, and reference numeral 1503 indicates a use number N3 of the type 3. These use numbers correspond to a result extracted from the net list of the floor plan result.

FIG. 16 is a diagram for explaining models of correction values between the modules, which are extracted in the feedback step ST7. In FIG. 16, reference numeral 1601 shows a memory reference numeral 1602 indicates a module 1, reference numeral 1603 denotes a module 2, reference numeral 1604 represents a wiring line between the memory and the module 1, and reference numeral 1205 shows a wiring line between the memory and the module 2. Reference numerals 1605 and 1607 show repeater buffers which are made in the model form so as to increase power measuring precision.

Models of these buffers are determined based upon an averaged drive distance of the buffer cells and a total number of the buffers, which have been obtained from FIG. 14 and FIG. 15. Both an averaged drive distance “Lm” and internal power consumption “Pm” of the modeled buffer cell are given from a formula 4 and a formula 5 respectively, assuming now that internal power consumption of the types 1, 2, 3 when a wiring load capacitance equal to the averaged drive distance Lm is defined as “P1” “P2” and “P3”:
Lm=(N1×L1+N2×L2+N3×L3)/(N1+N2+N3) (Formula 4)
Pm=(P1×N1+P2×N2+P3×N3)/(N1+N2+N3) (Formula 5)

While these values are used, “ΣPm” is employed as a correction value to correct the power consumption Pb of the wiring lines between the modules of the formula 2. Thereafter, the corrected power consumption is fed back to the cycle base simulation ST2. In other words, power consumption “Pb1” after the correction is made is given by the following formula 6:
Pb1=Pb+ΣPm (Formula 6)

In this example, the buffers have been modeled by using both the formula 4 and the formula 5. Alternatively, another method for using a cell of a buffer type whose use rate is high may become effective as a simple manner.

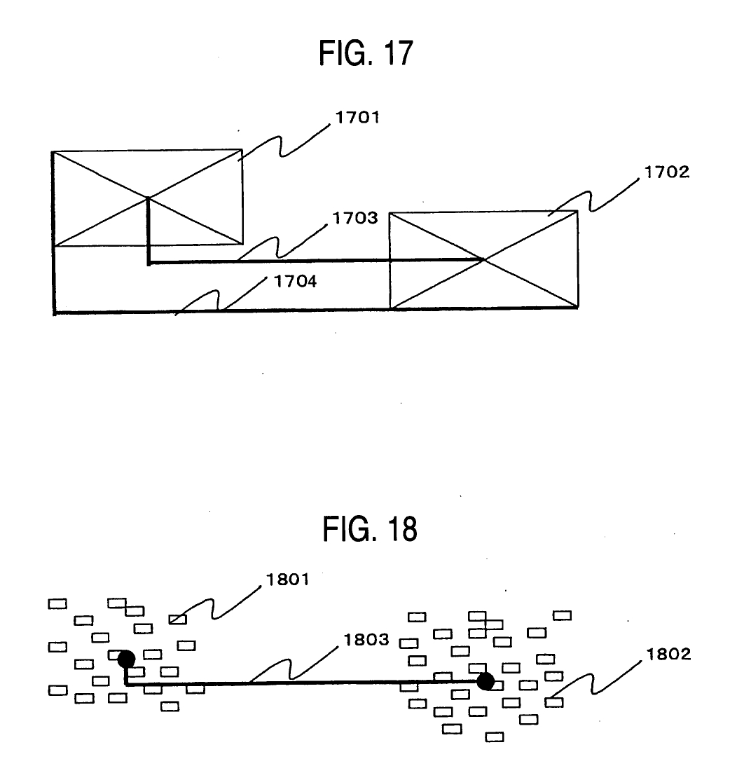

FIG. 17 is a diagram for explaining a distance between hard macro modules where a cell region extracted in the feedback step ST7 has been defined. In FIG. 17, reference numeral 1701 indicates a module 1, reference numeral 1702 denotes a module 2, reference numeral 1204 represents a distance between the module 1 and the module 2, and reference numeral 1704 shows the longest distance between the module 1 and the module 2. The distances correspond to distances between gravity positions of the respective modules. As to a module such as a macro, it is effective to analyze power by the longest distance.

FIG. 18 is diagram for explaining a distance between modules having expanses which have not be macro-processed, which is extracted in the feedback step ST7. In FIG. 18, reference numeral 1801 shows a cell group of a module 1, reference numeral 1802 indicates a cell group of a module 2, and reference numeral 1803 is a gravity distance between the module 1 and the module 2. In this case, gravity points (X1,Y1) and (X2,Y2) are calculated in accordance with the below-mentioned formula 7 and formula 8, assuming now that X coordinates of the respective cells are “X1k” and “X2k”, and Y coordinates of the respective cells are “Y1k” and “Y2k”:
(X1,Y1)=(Σ×1k/N1,ΣY1k/N1) (Formula 7)
(X2,Y2)=(Σ×2k/N2,ΣY2k/N2) (Formula 8)

Based upon these results, a relative distance “L12” between the module 1 and the module 2 is calculated in accordance with formula 9. In this case, only a 90-degree direction is assumed as to the wiring direction. When a 45-degree direction is employed, a distance is similarly calculated by considering an inclined wiring line:
L12=√((X1−X2)\hat{ }2+(Y1−Y2)\hat{ }2) (Formula 9)

As previously described, the correction value obtained by the formula 6, the relative distance between the modules obtained by the formula 9, the relative wiring distances changed in the arranging/wiring processes of FIG. 11 to FIG. 13, the wiring capacitance per unit distance which has been extracted from the wiring width and the wiring pitch, and the correction value which has been extracted from the changed result to the different sort of the cell, and the like are fed back to the floor plane.

The above-described steps are repeatedly carried out, and in the timing and power confirming step ST8, it is so confirm that the specifications can be finally satisfied in view of both the timing aspect and the power consumption aspect. As previously explained, in accordance with the low power consumption designing method of this embodiment mode, the precise power analysis can be carried out every module, and the power analysis results are reflected to the floor plan, designing of the power supply, and the arranging/wiring process, so that the low power consumption can be realized.

### Embodiment Mode 4

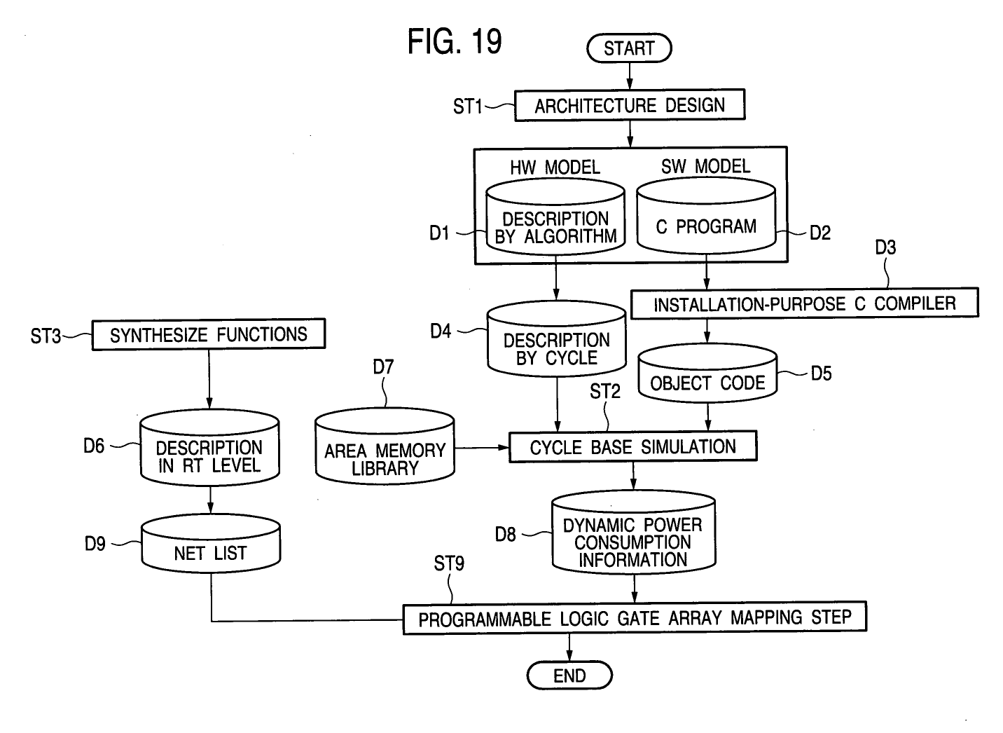

FIG. 19 is a flow chart for describing a low power consumption designing method of a semiconductor integrated circuit, accordion to an embodiment mode 4 of the present invention, in such a case that a programmable logic gate array is a design subject. In FIG. 19, designing process steps up to a programmable logic gate array mapping step ST9 until both the dynamic power consumption information D8 and the net list D9 are obtained correspond to contents of the embodiment mode 3.

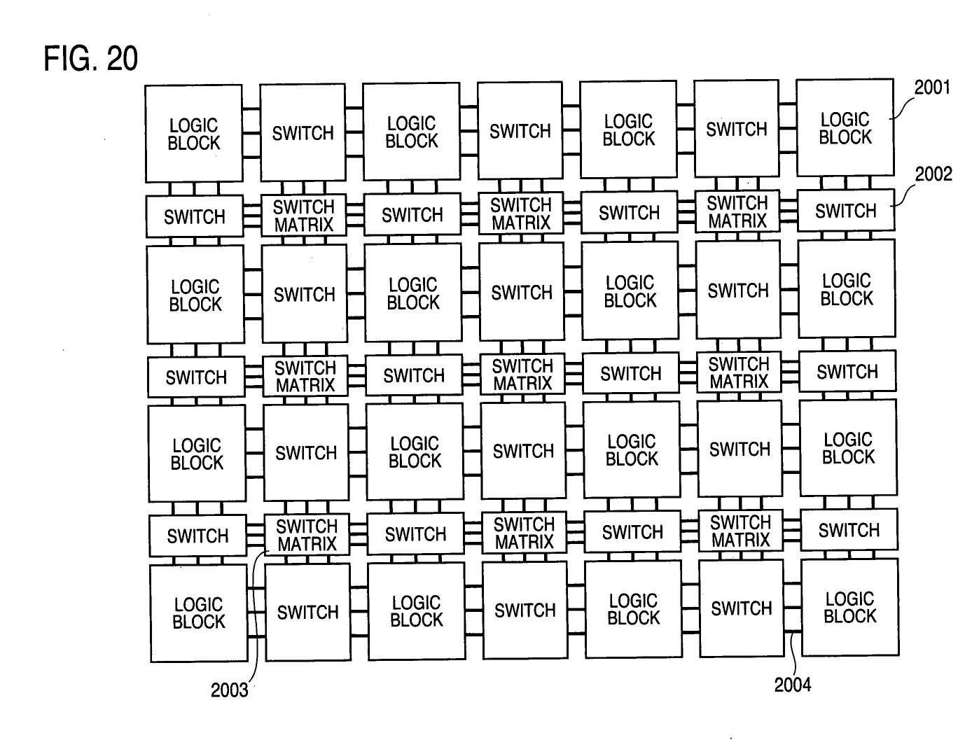

In the programmable logic gate array mapping step ST9, as indicated in FIG. 20, when a mode of a final product corresponds to such a programmable logic gate array as an FPGA, a mapping operation as to function blocks is carried out in such a manner that expanses of the respective logic blocks are minimized in this order from a function block having large power consumption based upon the dynamic power consumption information D8. The programmable logic gate array is constituted by a logic block 2001 containing a lookup table and a memory, a switch 2002, a switch matrix 2003, and a wiring line 2004.

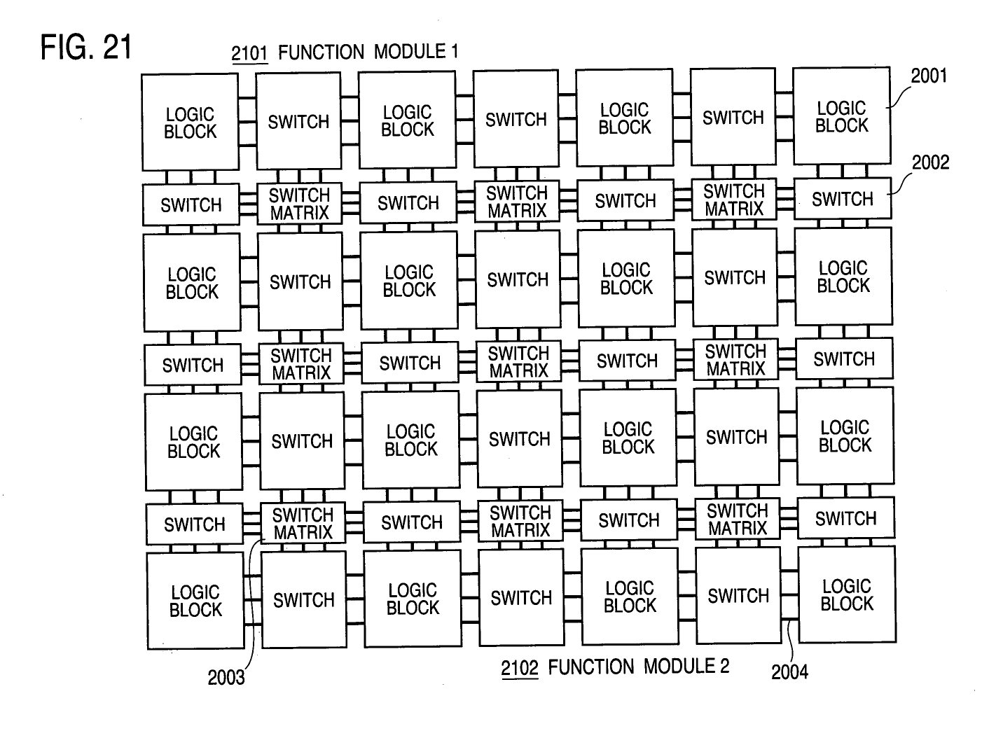

FIG. 21 indicates an embodiment of the above-described mapping operation. When power consumption of the function block 1 is maximum consumption in the power consumption information D8, this function block 1 is selected as such a block which is firstly mapped, and then, is arranged in 2101. Subsequently, when the power consumption of the function block 2 is second maximum consumption, this function block 2 is selected as a block which is subsequently mapped, and then, is arranged in 2102. Thereafter, function blocks are repeatedly mapped until a final block mapping operation is accomplished.

Since the simulation apparatus and the method for designing the semiconductor integrated circuit own the equivalent operation to those of the hardware and realize the high-speed simulation, these simulation apparatus and designing method may be applied as an architecture analysis and a software developing-purpose platform. Also, very recently, huge amounts of software for designing integrated circuits which involve power consumption measuring and low power consumption designing have been developed. As a consequence, in particular, the simulation apparatus and the semiconductor integrated circuit designing method, according to the present invention, may also be applied to designing of semiconductor integrated circuits employed in portable appliances which are typically known as portable telephones and which require power consumption analysis and low power consumption.

1. A simulation apparatus of a semiconductor integrated circuit, in which an operation thereof has been described in a clock level, the simulation apparatus comprising:
one or more sets of calculation modules, in which algorithm descriptions of a process content of a circuit to be designed to are converted into both a calculation and a memory access which are processed in a unit clock;
a state control module, in which an input parameter of the calculation module model and a transition of a control state in a unit clock for controlling both a commencement of an operation and an end of the operation are described; and
one or more sets of memory models, in which memories are simulated in an array.

2. The simulation apparatus according to claim 1, wherein the unit clock in the state control module model and the unit clock of the calculation module model, correspond to one function call.

3. The simulation apparatus according to claim 1 or 2 wherein:
a state for waiting designated variable numbers of clocks is provided in the state control module model so as to adjust a shift in timing as to either the commencement of the operation or the end of the operation between the calculation module model and the circuit to be designed.

4. The simulation apparatus according to any one of claim 1 to claim 3, further comprising:
a function capable of measuring both an activated condition of the calculation module model and an activated condition of the memory model every time a constant section has elapsed.

5. The simulation apparatus according to claim 4, further comprising:
a database, which has stored:
an operating frequency, a total gate number, and a power consumption value per unit gate with respect to each of the calculation module models; and
a power consumption value per unit frequency of the memory model.

6. The simulation apparatus according to claim 5, further comprising:
a function capable of calculating a power consumption value every time the constant section has elapsed from the activated conditions of the calculation module model and the memory model, and the database.

7. The simulation apparatus according to claim 6, wherein:
both wiring distance information defined from the calculation module model up to the memory model, and a wiring capacitance per unit distance are stored in the database.

8. The simulation apparatus according to claim 7 wherein:
the function capable of calculating the power consumption value every time the constant section has elapsed includes:
a function capable of calculating a load capacitance of the wiring line defined from the calculation module model up to the memory model, and capable of calculating a power consumption value of the wiring line defined from the calculation module model up to the memory model based upon the database.

9. The simulation apparatus according to any one of claim 6 to claim 8, further comprising:
a function capable of multiplying a correction value with respect to the power consumption value.

10. The simulation apparatus according to any one of claim 4 to claim 9, wherein:
values as to the constant section and the database can be changed by being accessed from an external unit.

11. The simulation apparatus according to any one of claim 6 to claim 10, further comprising:
a function capable of sectioning the power consumption value every the calculation module model so as to display the sectioned power consumption values.

12. The simulation apparatus according to any one of claim 6 to claim 11, further comprising:
a function capable of sectioning the power consumption value every the memory model so as to display the sectioned power consumption values.

13. The simulation apparatus according to any one of claim 6 to claim 12, further comprising
one, or more sets of processors operated in correspondence with a processor operation every unit clock of either a CPU (central processing unit) or a DSP (digital signal processor).

14. A method of designing a semiconductor integrated circuit, comprising:
a step A for determining an optimum solution of a relative position of each of function modules of a circuit to be designed based upon the power consumption value every the calculation module model and the power consumption value every the memory model, which are calculated in the simulation apparatus according to any one of claim 6 to claim 13;
a step B for determining an optimum arranging position with respect to each of the function modules in view of timing;
a step C for returning both a wiring capacitance per unit distance and a correction value to the simulation apparatus, which are extracted from distance information, a wiring width, and a wiring pitch based upon the determined arranging position, the step A, the step B, and the step C being repeatedly executed; and
a step D for determining an optimum arranging position of each of the function modules.

15. The designing method of a semiconductor integrated circuit, according to claim 14 wherein:
a step BO for determining a power supply width and a power supply pitch based upon the power consumption is further comprised between the step A and the step B.

16. The designing method of a semiconductor integrated circuit according to claim 14, or 15 wherein:
while the designing sequences defined from the step A up to the step C are repeatedly executed, either plural function modules or plural memories, the power consumption values of which are high, are arranged adjacent to each other in a top priority.

17. The designing method of a semiconductor integrated circuit according to claim 14, or 15 wherein:
in the step C, the distance information is calculated from a gravity position of each of the function modules.

18. The designing method of a semiconductor integrated circuit according to claim 14, or 15 wherein:
in the step C, the distance information is calculated from the longest distance among the respective function modules.

19. The designing method of a semiconductor integrated circuit according to claim 14, or 15 wherein:
while the designing sequences defined from the step A up to the step C are repeatedly carried out, threshold voltages of the respective function modules are changed so as to calculate a correction value from a threshold voltage which satisfies a specification in view of timing.

20. The designing method of a semiconductor integrated circuit according to claim 14, or 15 wherein:
while the designing sequences defined from the step A up to the step C are repeatedly carried out, the correction value in the step C is calculated from a stage number of inserted buffers.

21. The designing method of a semiconductor integrated circuit according to claim 14, or 15 wherein:
while the designing sequences defined from the step A up to the step C are repeatedly carried out, a pitch of wiring lines between the function modules whose power consumption values are high is made wide.

22. The designing method of a semiconductor integrated circuit according to claim 15 wherein:
in the step BO, after the section for calculating the power consumption value is decreased and peak power is measured, a power supply main route is wired in a top priority at a position for arranging a function module which is caused by the peak power, or a capacitance cell is reinforced.

23. The method for designing a semiconductor integrated circuit wherein:
in the case that the semiconductor integrated circuit corresponds to a programmable logic gate array which is constituted by a logic block containing a lookup table, a flip-flop, and by a memory, a wiring line, and also a switching element,
based upon the power consumption values either every the calculation module model or every the memory model, which are calculated in the simulation apparatus as recited in any one of claim 6 to claim 13, either calculation module models or memory models, whose power consumption values are high, are mapped to the logic block in a top priority.

24. The designing method of a semiconductor integrated circuit according to claim 23, wherein:
the programmable logic gate array corresponds to a programmable logic gate array which can be dynamically reconstructed.

25. The designing method of a semiconductor integrated circuit according to claim 24, wherein:
when either the calculation module models or the memory models, whose power consumption values are high, are mapped to the logic block in the top priority, a logic block is determined which is mapped in a top priority based upon the activated condition of the calculation module model every time the constant section has elapsed, as recited in claim 4.

26. A designing apparatus of a semiconductor integrated circuit wherein:
the designing apparatus executes the method for designing the semiconductor integrated circuit, recited in any one of claim 14 to claim 25.

27. A designing program of a semiconductor integrated circuit wherein:
the designing program executes the method for designing the semiconductor integrated circuit, recited in any one of claim 14 to claim 25.
